(19) United States
(12) Patent Application Publication
(10) Pub. No.: US 2011/0310022 A1
(43) Pub. Date: Dec. 22, 2011

(54) Responsive virtual image labeling of computer keyboards

(76) Inventor: Everett Simons, Arlington, VA (US)

(21) Appl. No.: 12/802,959

(22) Filed: Jun. 17, 2010

(51) Int. Cl. G06F 3/02; G08B 5/36

(52) U.S. Cl. 345/169; 340/815.53

(57) ABSTRACT

A user views a keyboard through a transparent plate. Partial reflection of an image source by the plate creates a virtual image, including labels, that appears to be superimposed on the keyboard. The keys themselves may be blank. Hands resting on the keyboard block the user's view of many of the keys, but do not block the view of the virtual image. The visual perception is that users can see the key labels through their own hands. This allows any key to be identified without moving the hands out of the way. The image source can be a computer-controlled monitor, which allows the virtual image labels to respond to user input. For example, pressing a control key can display virtual image labels for the shortcuts enabled by that control key. These virtual image labels can emphasize frequently used shortcuts, and also point out rarely used shortcuts to frequently used functions.

### BACKGROUND OF THE INVENTION

1. Field of the Invention

The invention relates to computer keyboards.

2. Description of Related Art

A computer keyboard typically includes an array of input keys, usually labeled with either one character, such as a letter, or two characters, such as “:” above “;”. Pressing an input key generates an associated character value. Computer keyboards usually include control keys, such as <Shift>, <Ctrl>, and <Alt>, that can modify the effect of pressing an input key. For example, with a 104-key PC U.S. English QWERTY keyboard, the key that would generate a semicolon (“;”) when pressed by itself would instead generate a colon (“:”) when pressed in conjunction with the <Shift> key. In some applications, pressing a key while holding the <Ctrl> key can activate a shortcut to a function; for example, pressing “C” while holding <Ctrl> may activate the “Copy” function. A computer keyboard usually also has an array of function keys, e.g. F1-F12, associated with various purposes, which may vary among applications.

Virtual reality headsets create a stereoscopic effect by providing separate image sources for the left and right eyes, viewed through two separate optical paths containing lenses. In this context, the term “virtual” means “simulated by computer”. The apparent distance from the user to a virtual object results from manipulating the apparent angle between the two depictions of the object in the two separate image sources to create apparent perspective, and not from the actual focal distance to the image source along the user's line of sight.

Virtual reality headsets use sensors to measure the location of the user's head. When the user's head turns, the computer tracks the motion and changes the image sources accordingly. This creates the visual perception that the virtual world reference positions remained fixed in space; i.e., the illusion of fixed location is created by changing the images in reaction to motion of the user's head.

In contrast, “virtual image” is an optical term for an image where the light appearing to emanate from one point did not actually originate at that point. For example, when an object is reflected in a mirror, the reflection is a type of virtual image. A monitor would thus not be brought within the definition of “virtual image” merely because a computer was generating an image and sending this image to the monitor. The term “virtual image ” is used herein only in the optical sense, not in the “computer-generated” sense.

With a heads-up display, the user views the real world through a transparent element, such as a windshield, and also sees the display reflected in the transparent element. This partial reflection is a type of virtual image. Such a virtual image can display data, e.g., vehicle speed.

### BRIEF SUMMARY OF THE INVENTION

One embodiment uses an image source above a keyboard, and a partially reflective transparent plate midway between the keyboard and the image source. When a user observes the keyboard by looking through the plate, the user sees both the keyboard and a virtual image of the image source, created by partial reflection. This virtual image contains labels for the keys; these virtual image labels appear to exist on the keys. The physical keys themselves may be blank.

The term “virtual image label” is being used herein to mean a label that is part of an inherently stationary virtual image with a focal distance equal to the actual distance along the user's line of sight to the physical object creating the image, and thus excludes holograms. Two adjacent observers would perceive the same virtual image label to be in the same location, despite the slight angle between their lines of sight. The term “virtual image label” excludes active headsets wherein the optical display reacts to the user's head motion to create the perception a depiction has fixed location. A label is not brought within the definition of “virtual image label” merely because the image containing the label was generated by computer.

When the user's hands are not on the keyboard, the user perceives a keyboard with labeled keys. Because the virtual image containing the key labels is created by a reflection from above the plate, nothing below the plate blocks the user's view of the key labels. Therefore, when the user's hands are operating the keyboard, the hands do not block the reflection, and the virtual image containing the key labels remains visible. Users thus have the visual impression of being able to see the key labels through their own hands. This allows the keys to be identified without requiring users to move their hands out of the way.

In some embodiments, the image source changes in response to user actions, e.g., pressing the control key <Ctrl> causing the various character key labels to display the associated shortcuts, such as the “C” virtual image label changing to “Copy” to indicate the function that would be activated by pressing the combination of <Ctrl> and the “C” key simultaneously, sometimes denoted as “̂C”. In some embodiments, the more frequently used combinations are emphasized. In some embodiments, the least frequently used combinations are omitted. In some embodiments, a compound virtual image label displays both the function and the shortcut, e.g. “Copy (̂C)”, for pedagogical reinforcement.

In some embodiments, the hue of a key's virtual image label changed from red to blue when the key was pressed. This created the visual perception of downwards motion: as the key was pressed down, the virtual image label apparently “on” the key seemed to move down with the key, even though the image source itself was a flat panel display.

In one embodiment, the image source and reflective plate were mounted in an adjustable frame that allowed the image source and reflective surface to move while keeping the virtual image stationary. This enabled the system to be adjusted, e.g. to accommodate users of different heights, while maintaining alignment of the virtual image labels relative to the associated keys.

### BRIEF DESCRIPTION OF THE SEVERAL VIEWS OF THE DRAWINGS

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description, serve to explain the principles of various aspects of the invention.

FIG. 1 illustrates an embodiment where the keyboard and image source are part of a laptop computer.

FIG. 2 illustrates a profile view of an embodiment where the source of the virtual image is above the screen of a computer.

FIG. 3 illustrates an articulated embodiment, allowing the image source to be tilted.

FIGS. 4A-C illustrate an angular articulation using bending elements.

FIG. 5 flowcharts the remapping of virtual image labels in response to control keys actuation.

In this disclosure, the use of the singular includes the possibility of the plural. The use of the term “with” is not limiting; similarly, the use of the terms “including” and “having”, as well as other forms of these terms such as “has”, are not limiting. The use of “or” means “and/or” unless stated otherwise. The sectional heading used herein are for organizational purposes only, and are not to be construed as limiting the subject matter described.

### DETAILED DESCTIPTION

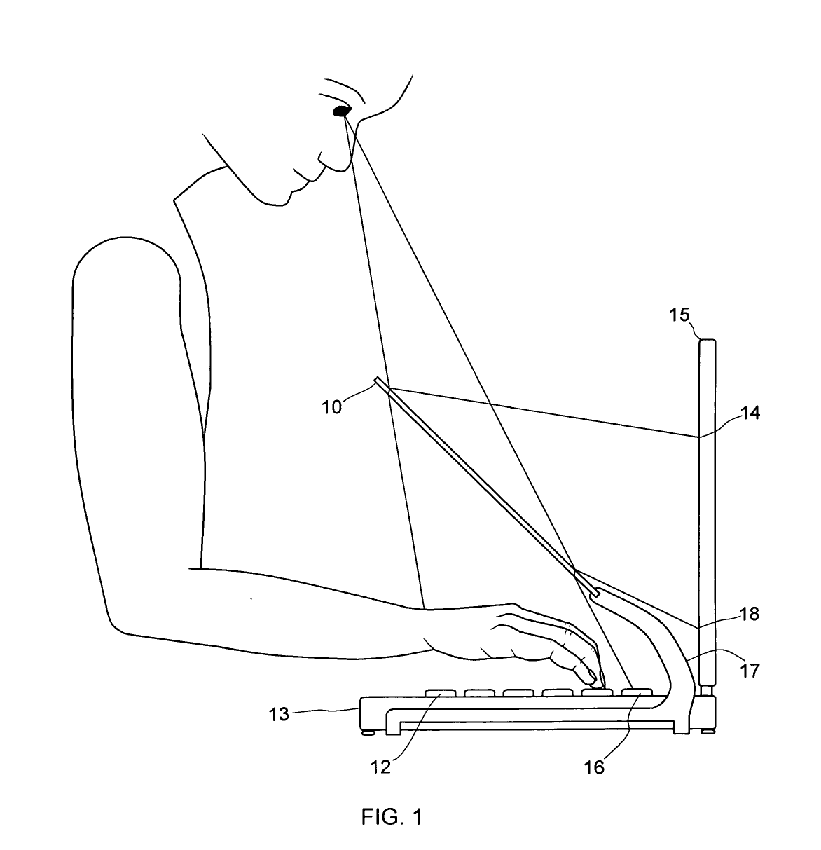

FIG. 1 illustrates an embodiment with a partially reflective transparent plate 10 held in place by bracket 17. A laptop computer provides both a keyboard 13 and an image source 15. Partial reflection of a key label at location 18 creates a virtual image label that appears to exist on key 16. The user's view of key 12 is blocked by the hand above, but partial reflection of a key label at location 14 creates a virtual image label that appears to exist at key 12. Thus, the user's hands do not block any of the virtual image labels of the keys. Such a system would typically be used in conjunction with a separate monitor (not shown) to display the application being run. Such monitor would be located behind image source 15 (beyond the right edge of FIG. 1). For clarity of illustration, FIG. 1 depicts bracket 17 as being part of a frame straddling the laptop computer. In some embodiments, the frame rests upon the horizontal portion of the laptop computer; in some embodiments, the frame is integral to the laptop computer.

The partially reflective transparent plate is preferably more reflective on the surface towards the image source than on the surface away from the image source. Some embodiments used glass as the reflective plate; others used plastic, such as polycarbonate. Including an anti-reflective coating on the lower surface reduced unwanted secondary reflections: a 0.02-0.04 mm layer of low density polyethylene was sufficient to reduce secondary reflections from the lower surface of an unmirrored glass plate. Other embodiments used a plastic plate with a reflective coating on the surface towards the image source. For some purposes, such as training users to “touch-type” without looking at their hands, the reflective surface need not transmit much if any light from the user's hands.

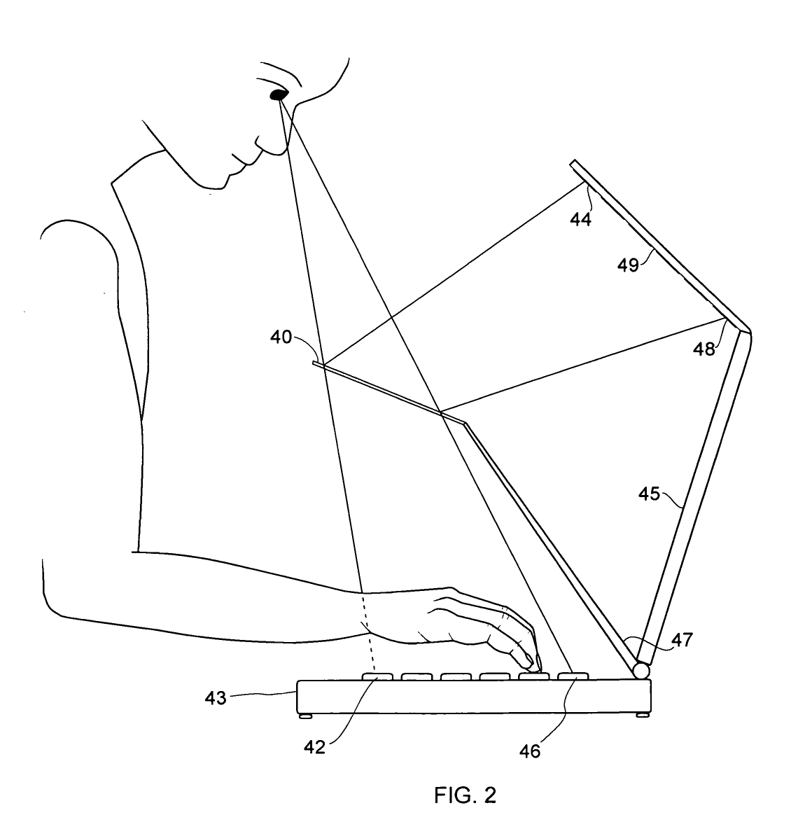

FIG. 2 illustrates an embodiment with a screen 45 and an image source 49. Reflection of the image source 49 by a flat transparent plate 40 (held in place by a bracket 47) creates a virtual image of the image source 49 in the plane of a keyboard 43. Thus, a key label at a location 48 on the image source 49 appears to exist on a key 46; a key label at a location 44 on the image source 49 appears to exist at the location of a key 42, even though the user's view of the actual key 42 is blocked by the user's hand. Neither the image source 49 nor the plate 40 impeded the user's view of the screen 45. In this embodiment, the same laptop computer provides both the keyboard 43 and the screen 45.

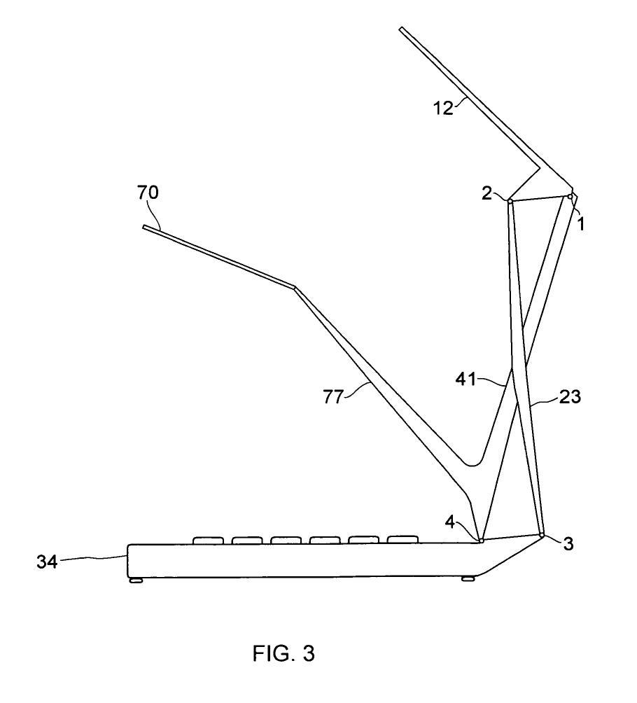

FIG. 3 illustrates an embodiment where an image source 12 moves and tilts, but the reflection of the image source 12 appears to remain fixed. A screen 41 attaches to a keyboard 34 at a pivot 4. The image source 12 attaches to the screen 41 at a pivot 1. A column 23 attaches to the image source 12 at a pivot 2; the column 23 also attaches to the keyboard 34 at a pivot 3. A bracket 77 mounts a flat transparent plate 70 to screen 41. Bracket 77 holds the plate 70 so as to bisect the plane of the image source 12 and the keys of keyboard 34. The virtual image created by reflection of the image source 12 in the plate 70 appears to exist in the plane of the keys of keyboard 34.

Together, pivots 1-4 comprise the articulations of a four-bar linkage, allowing the image source 12 to be tilted to accommodate users of different heights. The linkage articulates with a single degree of freedom; i.e., the angle between any two adjacent pivots uniquely determines the configuration of the entire system. The bracket 77 rigidly mounts plate 70 to screen 41; thus, the plate 70 and the screen 41 both rotate by the same angle (relative to the keyboard 34) when the system is adjusted.

When the image source 12 moves and tilts, the virtual image created by reflection of the image source 12 in plate 70 remains aligned with the keys; this shall be defined herein as a “synchronous articulation”. In this embodiment, the distance between pivot 1 and pivot 2 equals the distance between pivot 3 and pivot 4. The square of the distance between pivot 1 and pivot 4 equals the square of the distance between pivot 2 and pivot 3 plus two times the square of the distance between pivot 1 and pivot 2. This particular geometric relationship maximizes the range over which the image source 12 can be moved while keeping the virtual image labels aligned to the keys.

The configuration illustrated in FIG. 3 represents the middle of the adjustment range, with angle 123 (pivot 1 to pivot 2 to pivot 3) and angle 234 (pivot 2 to pivot 3 to pivot 4) both at 90 degrees, and angle 341 equal to angle 412. As the system articulates so as to move image source 12 towards the user (to the left in FIG. 3), angles 123 and 143 increase, and angles 412 and 432 decrease; the magnitudes of the four changes are essentially identical. In one embodiment, adjusting the image source +/− six degrees from the illustrated configuration caused no discernable motion of the virtual image labels, even though both the image source 12 and the plate 70 moved relative to the keyboard 34 and to each other.

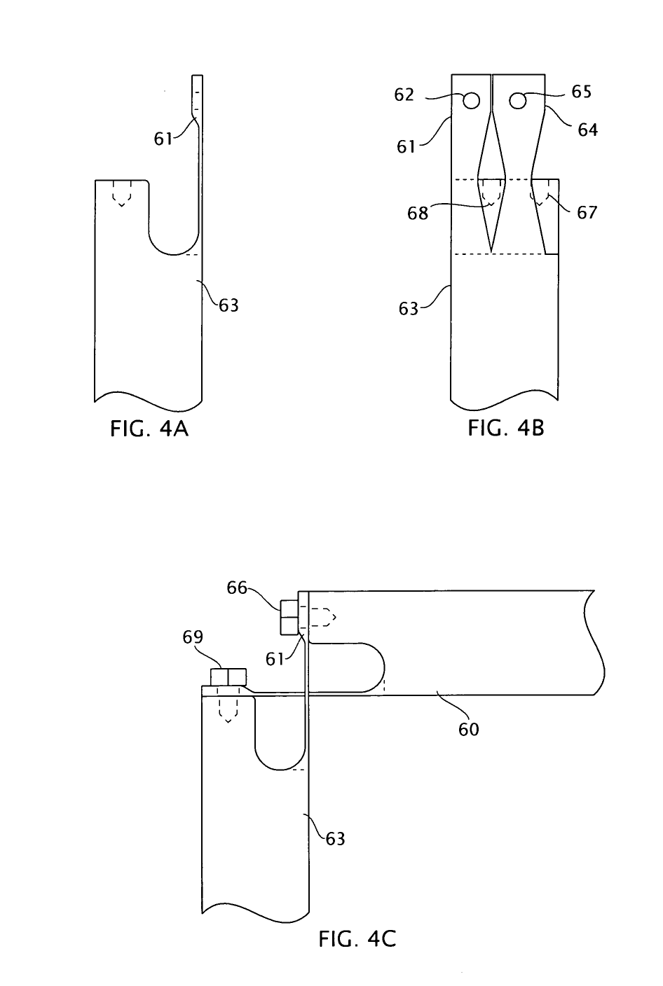

FIG. 4C illustrates a flexure, defined herein as a single degree of freedom angular articulation based upon bending rather than rolling or sliding. This flexure is formed by joining together two arms with identical ends. FIG. 4A and FIG. 4B show two different views of the same arm 63. FIG. 4B shows mounting hole 67 and mounting hole 68 within arm 63. Leaf spring 61 has a clearance hole 62; leaf spring 64 has a clearance hole 65. FIG. 4C illustrates the interleaved nature of these leaf springs when the two arms are joined. A pair of screws 66 through clearance holes 62 and 65 and into the mounting holes in arm 60; another pair of screws 69 pass through the clearance holes of the leaf springs of arm 60 and into their respective mounting holes 67 and 68 in arm 63. Defining arm 63 as a reference frame, arm 60 can angularly articulate about the point where the leaf springs pass through each other. However, arm 60 can not rotate about its own axis (due to leaf spring 61), and can not move along its own axis or along the axis of bar 63, and can not move perpendicular to the two bars (due to the resistance of each leaf spring to shearing). Such a flexure tends to be both stronger and stiffer than a comparable bearing. Alternatively, the interfaces between the arms could be glued together or mechanically joined without additional fasteners, such as by an interference fit. A flexure could also be molded as a unit rather than formed from two separate pieces.

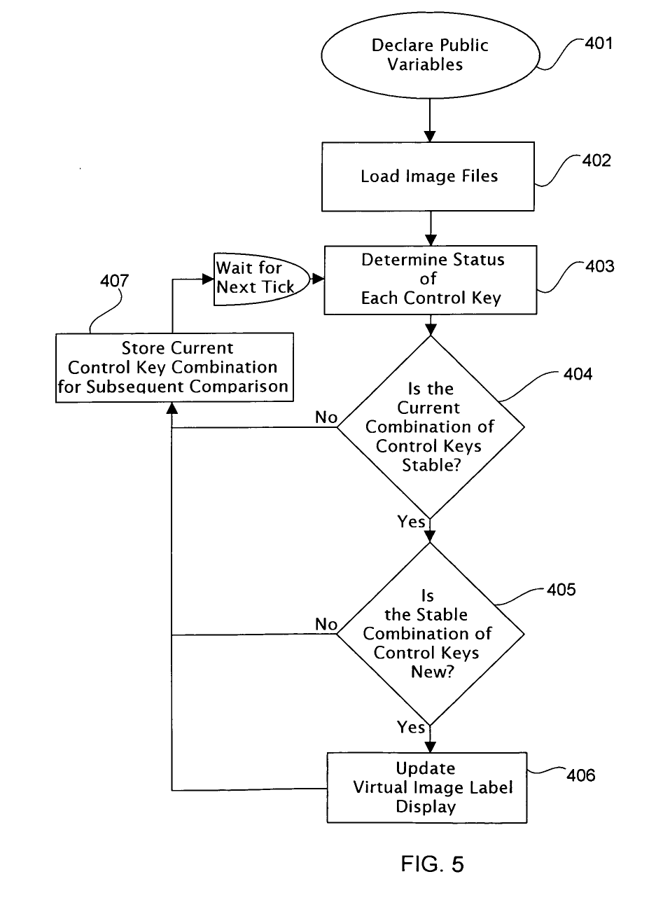

FIG. 5 flowcharts an embodiment of the remapping of virtual image labels in response to actuation of the control keys in various combinations. In step 401 the public variables are declared, including those intended to hold images, which are initialized in step 402. The status of each of the control keys is then determined in step 403. For example, Microsoft Visual Basic 2008™ provides Booleans such as “My.Computer.Keyboard.AltKeyDown” which indicates the <Alt> control key status independent of character key actuation. In step 404, the combination of control keys being held down by the user is then checked against the combination from the prior iteration of the loop. If the combination of control keys remains unchanged from the last iteration, the current combination of control keys is considered stable. In step 405, this combination is checked to see whether this control key combination is new. If so, the image being displayed by the image source is updated in step 406 to reflect the virtual image labels corresponding to the new combination of control keys being pressed. Step 407 stores the current control key combination, regardless of whether such combination is stable or new. The system then waits for the iteration to begin.

If, in step 404, the combination of control keys being held down by the user has changed since the last iteration, the virtual image labels are not immediately updated. Thus, when a combination of control keys is pressed (or released) almost but not quite simultaneously, the virtual image labels ignore the momentary intermediate state(s). For example, when <Ctrl> and <Alt> are pressed at almost the same time, neither the functions associated solely with <Ctrl> nor the functions associated solely with <Alt> are displayed by the virtual image. Rather, the system waits until the control key combination remains unchanged for two consecutive iterations, and then displays the functions associated with the combination of <Ctrl> and <Alt>, e.g., relabeling the “Delete” key to read “Task Manager”.

If, in step 405, the combination of control keys being held down by the user corresponds to the virtual image label display already active, then the stable combination is not new, and there is no need to change the virtual image label display.

When one or more control keys are pressed, the resulting changes in functionality of other keys can be indicating by highlighting virtual image labels that were already visible, or by providing a completely new or different virtual image label. For example, in some embodiments, holding the <Shift> key highlighted characters that were already visible, such as “<”, “:”, “{”, “!”, “@”, “#”, etc., but holding the <Ctrl> key caused the virtual image to display completely new function labels, such as “Copy” at the “C” key, “Paste” at the “V” key, etc.

Some embodiments expanded certain virtual image labels while contracting adjacent labels, to accommodate longer descriptions by encroaching slightly over adjacent keys. For example, holding the <Shift> key caused the “Delete” virtual image label to become “Delete/without/placing in/recycle bin” (where each “/” denotes a line break); this required enlarging the allocated area at the expense of adjacent labels. Some embodiments allowed the virtual image labels to expand beyond the extent of the keyboard itself; this was particularly useful for expanding descriptions of function keys located along the top row of the keyboard.

Some embodiments created the perception that a key's virtual image label also moved down when the key was pressed. This was done by shifting the hue of the virtual image label from a longer wavelength to a shorter one. The best results were obtained when both hues were pure colors, such as red and blue. The term “pure color” is being used herein to denote the hues depicted by the sub-pixel elements of a particular image source, typically red, green, and blue. The term “highly saturated” will be used herein to denote a color where most of the intensity comes from a single pure color, and less than ⅕ of the intensity comes from any other color. Even though the image source was planar, the color shift created the visual perception that the key had moved “downwards”, that is, into the plane of the keyboard. This effect was especially pronounced when the default virtual image label was red surrounded by a black border in a generally red background, and the virtual image label changed to blue when the key was pressed. The effect was enhanced when the location of the newly blue virtual image label moved within the plane of the keyboard to match the apparent (pressed) position of the key; for a an apparent change in key height h observed at an angle g, measured from a perpendicular line to the plane of the keyboard, the resulting lateral displacement equals h*tan(g).

Each application can provide a customized set of maps associating the various control key combinations with their resulting functions. The application can provide text for the labels, and the virtual image software can create the associated images, so other applications need not provide hardware-specific image files.

Opening an application can open a new instance of the virtual image labeling software in a separate window displayed on the image source. While that application is running, the associated instance of the virtual image labeling software can remain the top window displayed by the image source, and react to holding one or more control keys by changing the display on the image source, thereby changing the virtual image labels of the keyboard. When the focus changes to a second application, the instance of the virtual image label software associated with the second application becomes the new top window on the image source. This simplifies the interface between each application and the virtual image label software while allowing application-specific virtual image labels.

In some embodiments, the more frequently used shortcuts were highlighted. For example, in some embodiments, pressing <Ctrl> caused all the enabled shortcuts to be displayed, but only the “Cut”, “Copy”, “Paste”, “Select all”, and “Save” shortcuts were highlighted. In some embodiments, the least frequently used shortcuts were omitted from the virtual image labeling, to simplify the choices displayed. Which shortcuts should be highlighted and which (if any) should be omitted can be chosen on an application-by-application basis, or by tracking the frequency of use for each shortcut and/or function and adapting the virtual image labeling accordingly.

Creating a user profile and tracking the frequency of shortcuts used within a particular application can allow the system to adapt to the that user. The term “statistic” shall be used herein to denote a particular number statistically related to a particular key or key combination. For example, an exponentially weighted moving average (EWMA) is a statistic that allows efficient tracking of a series of data points. The term “profile” shall be used herein to denote a set of statistics. With an EWMA, each new data point could have a weighting of 0.01 and the prior EWMA would thus have a weighting of 0.99; after the initialization period, this causes the weighting factor for each event to decrease exponentially as subsequent events occur. To store the usage frequency of the combination of <Ctrl> and “C” (denoted “̂C”) with a weighting factor of 0.01, every time that combination was used the new EWMA for ̂C would be set to

EWMÂC(new)=0.99×EWMA(old)+0.01×MAX,

but every time <Ctrl> was used in combination with any other key (but not another control key), the new EWMA for ̂C would be set to

EWMÂC(new)=0.99×EWMA(old),

where “MAX” denotes the largest storable value, and non-occurrence is defined as zero; the value of 0.01×MAX remains constant, and need not be recalculated every cycle. For each combination, the running frequency, on a scale of 0 to 1, would thus be EWMA/MAX. A separate statistic is stored for every combination being tracked, but the precision of floating point numbers is not required. For a 16 bit unsigned integer, MAX=65,535, and the value of each statistic would range from 0 to 65,535. A user profile could consist of a statistic for each of the functions and shortcuts being tracked.

Where computational speed is at a premium, the weighting factors can be chosen so as to substitute a bit shift and subtraction for the multiplication. For example, if the weighting factor for each new point were set to 1/256 (rather than 1/100), the new EWMA for a negative result would be

EWMA(new)=(1− 1/256)×EWMA(old)=EWMA(old)−EWMA(old)/256

which can be accomplished by subtracting from EWMA(old) a eight bit shifted copy of itself.

If the system tracks the shortcuts activated by the user, the system can adapt the virtual image labels to display the shortcuts that the user actually invokes. However, if the system also tracks activation of the functions themselves, the system can adapt to what the user might like to do, by highlighting rarely used shortcuts to frequently used functions.

Multiple sets of exponentially weighted moving averages can be used to determine whether the circumstances of use have significantly changed. For example, three sets of weighting factors, 0.001/0.999, 0.01/0.99, and 0.1/0.9, could be use to track the long-term profile, medium-term profile, and short-term pattern. The long-term and medium-term profiles can then be checked against the short-term pattern, by calculating their dot products, to see which profile provides the best match to the current usage pattern. Using the short-term pattern to choose between displaying virtual image labels based on either the long-term or medium-term profile, rather than using a short-term profile, is intended to reduce the required frequency of changes to the shortcuts displayed for each control key or combination of control keys.

Compound virtual image labels, e.g., “Copy (̂C)”, can remind the user about particular shortcuts. For example, by tracking the average interval between holding down a control key and subsequently pressing a particular character key, in this case <Ctrl> and “C” respectively, the system can detect which shortcuts the user has difficulty remembering. The virtual image labels of these shortcuts can subsequently be highlighted or have a compound virtual image label, rendering them more memorable. If desired, these compound virtual image labels can be displayed even in the absence of control key actuation. Once user speed for a particular shortcut improves, the virtual image labeling of that shortcut can revert to the default. Compound or highlighted labels can also be displayed for rarely used shortcuts to frequently used functions, since such a situation implies that the user is relatively unfamiliar with that shortcut. The general term “distinguish” shall be defined as emphasizing a particular virtual image label or labels, such as by highlighting, underlining, or changing font.

I claim:

1. An apparatus for providing virtual image labels for a manual input portion of an electronic input device by partial reflection of an image source, comprising:
a partially reflective transparent plate; and
an alignment system configured to position the plate so as to bisect the manual input portion and the image source,
thereby superimposing a partial reflection of the image source at the manual input portion of the electronic input device,
whereby the virtual image labels appears to exist on the manual input portion of the electronic input device.

2. The apparatus of claim 1,
wherein the image source comprises a display screen of a laptop computer; and
wherein the electronic input device comprises a keyboard of the laptop computer.

3. A laptop computer comprising the apparatus of claim 1.

4. The apparatus of claim 1,
wherein the alignment system comprises a synchronous articulation configured to allow motion of the image source relative to the electronic input device while the virtual image labels remains aligned to the manual input portion of the electronic input device.

5. The apparatus of claim 4,
wherein the synchronous articulation comprises a four-bar linkage comprising:
a first angular articulation of the image source relative to the plate;
a second angular articulation of the plate relative to the electronic input device;
a synchronizing bar;
a third angular articulation of the electronic input device relative to the synchronizing bar; and
a fourth angular articulation of the synchronizing bar relative to the image source,
whereby the virtual image label remains aligned to the manual input portion of the electronic input device despite motion of the image source relative to the manual input portion of the electronic input device.

6. The apparatus of claim 5, wherein at least one of the angular articulations comprises a flexure.

7. A method for labeling a keyboard using an image source and a partially reflective transparent plate, wherein the keyboard comprises a first input key, a second input key, and a first control key, the method comprising the steps of:
detecting actuation of the first control key by a user; and
modifying the appearance of the image source in response to the detected actuation of the first control key,
whereby partial reflection of the image source in the plate creates both
(1) a first virtual image label at the first input key indicating a change in functionality of the first input key due to actuation of the first control key, and
(2) a second virtual image label at the second input key indicating a change in functionality of the second input key due to actuation of the first control key.

8. The method of claim 7,
wherein actuation of the first input key in isolation generates a first character; and
wherein activation of the second input key in isolation generates a second character different from the first character.

9. The method of claim 8,
wherein actuation of the first input key in conjunction with actuation of the control key activates a first function, and
wherein actuation of the second input key in conjunction with actuation of the control key activates a second function different from the first function.

10. The method of claim 7,
comprising the additional steps of:
obtaining a first value associated with actuation of the first input key in conjunction with the first control key;
obtaining a second value associated with actuation of the second input key in conjunction with the first control key;
determining that the first value is above a threshold and the second value is below the threshold; and
distinguishing the first virtual image label from the second virtual image label in response to the determination that the first value is above the threshold and the second value is below the threshold.

11. The method of claim 10,
wherein the first value relates to a predicted probability that the user will actuate the first input key in conjunction with the first control key, and
wherein the second value relates to a predicted probability that the user will actuate the second input key in conjunction with the first control key,
thereby responding to user actuation of the first control key in isolation by distinguishing the first virtual image label from the second virtual image label based on different predicted probabilities of
the user then pressing the first input key or
the user then pressing the second input key.

12. The method of claim 10,
wherein the first value derives from past measurements of the duration between actuation of the first control key and
subsequent actuation of the first input key without release of the first control key, and
wherein the second value derives from past measurement of the duration between actuation of the first control key and
subsequent actuation of the second input key without release of the first control key,
thereby responding to actuation of the first control key in isolation by distinguishing the first virtual image label from the second virtual image label, based upon an apparent difference in facility between
combining the first input key with the first control key and
combining the second input key with the first control key.

13. The method of claim 7,
wherein the keyboard further comprises at least a second control key, the method further comprising the steps of:
detecting what combination of control of keys is being actuated;
modifying the first virtual image label to indicate the functionality associated with pressing the first input key in conjunction with the detected combination of actuated control keys; and
modifying the second virtual image label to indicate the functionality associated with pressing the second input key in conjunction with the detected combination of actuated control keys.

14. A computer-readable medium for use on a computer system, the computer-readable medium having computer-executable instructions for performing the method of claim 7.

15. A computer-readable medium for use on a computer system, the computer-readable medium having computer-executable instructions for performing the method of claim 8.

16. A computer-readable medium for use on a computer system, the computer-readable medium having computer-executable instructions for performing the method of claim 9.

17. A computer-readable medium for use on a computer system, the computer-readable medium having computer-executable instructions for performing the method of claim 10.

18. A computer-readable medium for use on a computer system, the computer-readable medium having computer-executable instructions for performing the method of claim 11.

19. A computer-readable medium for use on a computer system, the computer-readable medium having computer-executable instructions for performing the method of claim 12.

20. A computer-readable medium for use on a computer system, the computer-readable medium having computer-executable instructions for performing the method of claim 13.

21. A method for indicating actuation of a first key within a keyboard having a plurality of keys, comprising the steps of:
labeling at least some of the plurality of keys with virtual image labels;
detecting actuation of the first key by a user; and
responding to the detected actuation of the first key by modifying the virtual image label at the first key.

22. The method of claim 21,
wherein the step of modifying the virtual image label in response to actuation of the first key comprises a shift in hue of the virtual image label to a shorter wavelength,
thereby creating the perception of downwards motion of the first key.

23. The method of claim 22,
wherein the step of modifying the virtual image label in response to actuation of the first key comprises a shift in hue of the virtual image label from a highly saturated hue of the longest wavelength pure color to a highly saturated hue of the shortest wavelength pure color.

24. A computer-readable medium for use on a computer system, the computer-readable medium having computer-executable instructions for performing the method of claim 21.

25. A computer-readable medium for use on a computer system, the computer-readable medium having computer-executable instructions for performing the method of claim 22.

26. A computer-readable medium for use on a computer system, the computer-readable medium having computer-executable instructions for performing the method of claim 23.
